(19) United States
(12) Patent Application Publication
(10) Pub. No.: US 2026/0349394 A1
(43) Pub. Date: Nov. 5, 2026

(54) METHOD AND MACHINE CONTROLLER FOR CONTROLLING A MACHINE

(71) Applicant: Siemens Aktiengesellschaft, München (DE)

(72) Inventors: Marc Christian Weber, München (DE); Steffen Limmer, München (DE); Volkmar Sterzing, München (DE); Kai Heesche, München (DE); Daniel Hein, München (DE); Ferdinand Strixner, München (DE); Clemens Otte, München (DE)

(21) Appl. No.: 19/665,205

(22) Filed: May 1, 2026

(30) Foreign Application Priority Data
May 5, 2025 (EP) 25174212.8

(51) Int. Cl. G05B 13/02; G05B 13/04

(52) U.S. Cl. CPC G05B 13/0265; G05B 13/042

(57) ABSTRACT

A learning-based control agent trained to output a control signal, optimized with respect to a performance target of the machine, for controlling the machine as a result of operating data and a target setting value being fed in is provided. Many different performance targets can be set by the target setting value. According to the invention, a multiplicity of different target setting values are generated. Furthermore, current operating data relating to the machine are captured and fed into the control agent together with a respective target setting value. The machine is then controlled by a control signal respectively output by the control agent. In addition, for different target setting values, in each case a performance of the machine that is superior to the individual performance targets is determined. Finally, a target setting value that optimizes the superior performance is determined and used in the further operation of the machine.

### CROSS-REFERENCE TO RELATED APPLICATIONS

This application claims priority to EP Application No. 25174212.8, having a filing date of May 5, 2026, the entire contents of which are hereby incorporated by reference.

### FIELD OF TECHNOLOGY

The following relates to a method and machine controller for controlling a machine.

### BACKGROUND

Data-driven machine learning methods are increasingly being used in the control of complex machines, for example robots, motors, production plants, machine tools, milling machines, gas turbines, wind turbines, cooling plants, heating plants or internal combustion engines.

Such learning methods can be used to train a machine controller to generate, for a respective operating state of the machine, a state-specific control action for controlling the machine that specifically brings about a desired or optimized behavior of the machine and thus optimizes the performance thereof. A learning-based method that is used to select a control action to be applied in the current state is often also referred to as a policy, control agent or action selection rule.

A multiplicity of known training methods is available for training such a learning-based control agent, such as reinforcement learning methods.

During the ongoing operation of a machine, the problem frequently arises of the operating conditions of the machine changing slowly or in an unforeseen manner, for example as a result of aging or as a result of weather influences. Insofar as such influences are often not yet known during the training of a control agent, are not foreseeable or are under-represented in the available training data, such a control agent acts increasingly sub optimally in many cases without specific adaptation.

Although the control agent can be retrained for adaptation to changed operating conditions, such retraining is often associated with high computational effort.

### SUMMARY

An aspect relates to a method and a machine controller for controlling a machine that require less complicated adaptation of the machine controller.

An aspect relates to a method having the features by way of a machine controller having the features by way of a computer program product (non-transitory computer readable storage medium having instructions, which when executed by a processor, perform actions) having the features of and by way of a computer-readable storage medium.

For controlling a machine, a learning-based control agent is provided and is trained to output a control signal, optimized with respect to a performance target of the machine, for controlling the machine as a result of operating data relating to the machine and a target setting value being fed in. In this case, a multiplicity of different performance targets can be set by the target setting value. In this case, the target setting value can be, in particular, scalar or vector-valued. If a plurality of discrete performance targets, such as an efficiency and a pollutant emission, are predefined, these can be weighted in particular by individual vector elements of a vector-valued target setting value. In this way, it is possible to interpolate between a plurality of discrete performance targets by the target setting value, in order to thus parametrize a quasi-continuous space of possible performance targets and to set a performance target which is favorable in a specific operating situation in fine-grained fashion. According to embodiments of the invention, a multiplicity of different target setting values is generated. Furthermore, current operating data relating to the machine are captured and fed into the control agent together with a respective one of the generated target setting values, and the machine is controlled by a control signal respectively output by the control agent. Furthermore, for different target setting values, in each case a performance of the machine that is superior to the individual performance targets is determined. Finally, a target setting value that optimizes the superior performance is determined and used in further operation of the machine.

In this case, the superior performance can relate in particular to operating conditions, operating states and/or performance targets which were not yet relevant or not accessible during the training of the control agent, for example weather-related or aging-related malfunctions. Thus, for example, it is possible to measure, as a superior performance, how often malfunctions occur in current operation, how often limit values are violated and/or to what extent limit values are violated. The superior performance can be scalar or vector-valued.

To carry out the method according to embodiments of the invention, there is provision for a machine controller, a computer program product and a, for example non-volatile, computer-readable storage medium.

The method according to embodiments of the invention as well as the machine controller according to embodiments of the invention can be executed or implemented for example by one or more processors. In embodiments, by application-specific integrated circuits (ASIC), digital signal processors (DSP) and/or so-called “field programmable gate arrays” (FPGA). The method according to embodiments of the invention can furthermore be carried out at least in part in a cloud and/or in an edge computing environment.

An advantage of embodiments of the invention can be seen in particular in the fact that the control of the machine can be adapted, during ongoing operation and without complicated retraining of the control agent, to changes in operating conditions and/or performance targets that were not yet foreseeable during the training of the control agent.

In many cases, once a control agent has been trained, it can continue to be operated unchanged, which can be a significant advantage, in particular in safety-critical applications.

In addition, embodiments of the invention can be carried out or used locally. A cloud or network connection is often not required.

Insofar as a superior performance can be optimized by embodiments of the invention, the invention can advantageously be used within the framework of known hierarchical optimization methods.

Furthermore, by analyzing optimizing target setting values determined over time, it is possible to obtain information about the contributions of the settable performance targets to the superior performance. In many cases, such information can be used to update safety limits in a performance-target-specific manner. In addition, such information can be used to assess a state of health of the machine or for predictive maintenance.

According to one embodiment of the invention, the control agent can be trained in advance by
providing a performance evaluator in which different performance targets of the machine can be set;
generating a multiplicity of training target setting values;
feeding operating data relating to the machine into the control agent together with a respective one of the training target setting values, wherein, parallel thereto, a respective performance target is set in the performance evaluator by the respective training target setting value;
determining a performance value specific to the respectively set performance target by way of the performance evaluator for controlling the machine by a control signal output by the control agent; and
training the control agent to optimize the determined performance values at least on statistical average.

The above training makes it possible to enable the control agent to output control signals for the machine, by which control signals a respectively settable performance target is optimized. In many cases, it can be observed that a control agent trained in this way has good interpolation and abstraction properties. That is to say, even if only a few individual performance targets are used during training, new combinations of these performance targets are frequently optimized relatively well when controlling the machine.

According to an embodiment of the invention, the multiplicity of target setting values can be generated by varying a first target setting value many times, for example on a random basis, wherein a statistical or maximum spread of the variations is limited by a predefined tolerance threshold. The first target setting value can then be updated by the target setting value that optimizes the determined superior performance. If the first target setting value is vector-valued, the variations may also be vector-valued. The tolerance threshold can be selected in such a way that, on the one hand, the variations have no or at least no significant effect on the control of the machine, and, on the other hand, gradients can still be numerically determined in a sufficiently stable manner according to the target setting value.

A respective variation can for example be triggered by an expiry of a predefined time period and/or by a predefined event, for example a system warning or an alarm. The time period can be selected such that the superior performance can be measured sufficiently reliably during this time period.

According to one embodiment of the invention, a gradient descent method can be used to determine the target setting value that optimizes the superior performance. In this case, it is possible to resort to a multiplicity of efficient standard methods which rapidly converge to an optimum result.

Furthermore, the superior performance can be quantified by a superior performance vector having a plurality of vector elements. In this case, a check can be carried out in order to determine whether there is a descending direction for the target setting value, along which a plurality of vector elements of the superior performance vector are improved simultaneously. As a result of a positive check result, the target setting value can then be shifted in the direction of this descending direction.

According to one development of embodiments of the invention, a plurality of identical machines can be controlled by the trained control agent. In this case, for the different target setting values in each case the superior performance of each machine can be measured, and these measurements can be averaged over the machines. A target setting value that optimizes the averaged superior performance can thus be determined and used in the further operation of the machines. In this way, measurements of the superior performance can be distributed over a plurality of machines and thus parallelized to a certain extent. On the basis of the larger number of measurements, correlations between the target setting values and the superior performance and thus also the optimizing target setting value can often be determined considerably more quickly and/or more reliably than on the basis of a single machine.

According to a development of embodiments of the invention, a plurality of identical machines can be controlled by the trained control agent, wherein a target setting value which optimizes the superior performance of each machine is respectively determined for the latter. The determined optimizing target setting values can then be averaged. Accordingly, the averaged optimizing target setting value can be used in the further operation of the machines. In this method variant, too, the optimizing target setting value can often be determined considerably more quickly and/or more reliably than on the basis of a single machine.

### BRIEF DESCRIPTION

Some of the embodiments will be described in detail, with reference to the following figures, wherein like designations denote like members, wherein:

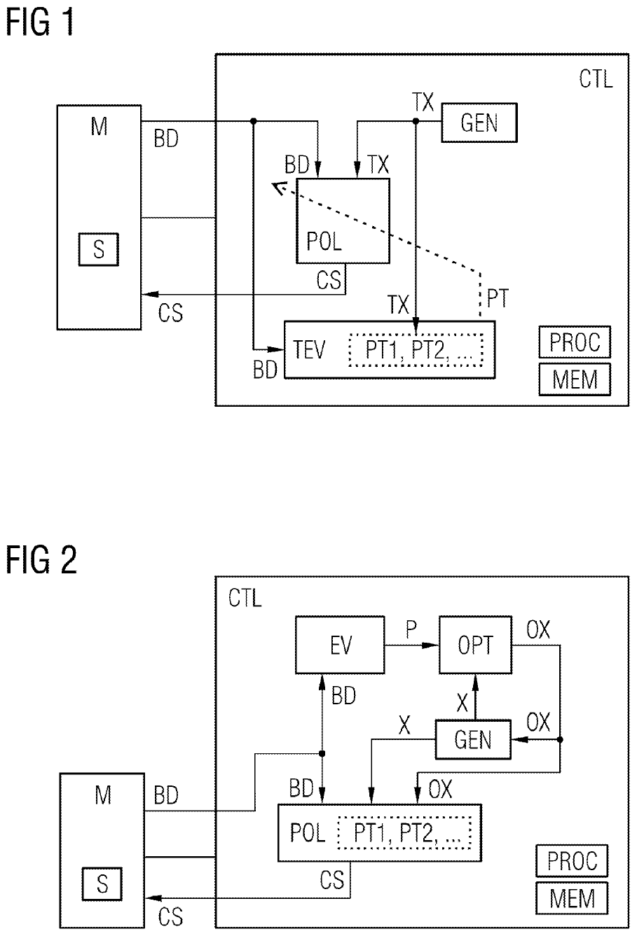

FIG. 1 shows a learning-based machine controller in a training phase; and

FIG. 2 shows the machine controller when controlling a machine.

Where the same or corresponding reference signs are used in different figures, these reference signs, unless otherwise indicated, denote the same or corresponding entities, which may in particular be implemented or embodied as described in connection with the figure in question.

### DETAILED DESCRIPTION

FIGS. 1 and 2 illustrate, by way of example, a learning-based machine controller CTL for controlling a machine M. The machine controller CTL comprises one or more processors PROC for executing embodiments of the method steps of the machine controller CTL and one or more memories MEM that are coupled to the processor PROC and intended to store the data to be processed by the machine controller CTL.

The machine controller CTL is coupled to the machine M which in the present exemplary embodiment is configured as a robot, for example as a production robot. Alternatively or additionally, the machine M may also be a motor, a production plant, a factory, a machine tool, a milling machine, a gas turbine, a wind turbine, a steam turbine, a chemical reactor, an internal combustion engine, a cooling plant or a heating plant.

The machine M has a sensor system S that continuously measures various current operating parameters of the machine M during ongoing operation, and outputs them as state values. The state values can be used in particular to quantify physical, control-related, chemical and/or effect-related state variables, sensor data, environmental data or other operating parameters that arise during operation of the machine M or influence operation. The state variables in this case can include a temperature, a pressure, a setting, an actuator position, a valve position, a pollutant emission, a utilization level, a resource consumption and/or a power of the machine M or a component thereof. In the case of a production plant or a machine tool, the state values can also include a product quality, a processing quality, or another product property. In the case of a turbine, the state values can include a turbine power, a rotation speed, vibration frequencies, vibration amplitudes, combustion dynamics, change of combustion pressure amplitudes or nitrogen oxide concentrations.

The state values currently measured by the sensor system S and, if appropriate, current operating parameters of the machine M determined in some other way, such as control data or environmental data, are continuously transmitted in the form of operating data BD from the machine M to the machine controller CTL. In this case, the operating data BD can be represented or described in particular by data vectors.

Control signals CS for controlling the machine M are continuously derived from the transmitted operating data BD by the machine controller CTL and transmitted to the machine. The machine M is controlled by the transmitted control signals CS.

The control signals CS are determined by a learning-based control agent POL of the machine learning module CTL. In this case, the control agent POL can comprise, in particular, an artificial neural network.

In a training phase, the control agent POL is trained to output control signals for the machine M on the basis of operating data relating to the machine M, by which control signals a settable performance target of the machine M is optimized. A respective performance target, with respect to which the control of the machine M should be optimized, is in this case set by a target setting value to be fed into the control agent. Optimization should also be understood as meaning a targeted approach to an optimum.

Performance targets that may be provided include, for example, the highest possible efficiency, the highest possible power, the highest possible yield, the highest possible speed, the highest possible precision, the highest possible efficiency, the highest possible stability, the longest possible lifetime, the lowest possible pollutant emission, the shortest possible running time, the lowest possible error rate, the lowest possible consumption of resources or the lowest possible wear of the machine M.

For the present exemplary embodiment, it is assumed that the target setting value is vector-valued with vector elements which can be assigned quasi-continuously. In this case, each vector element is assigned to a predefined performance target in order to weight it relative to the other performance targets. In this way, it is possible to interpolate quasi-continuously between a plurality of predefined performance targets by the target setting value, in order to set a performance target which is favorable in a specific operating situation in fine-grained fashion. The quasi-continuous settability of the performance target allows the use of gradient-based optimization methods for determining an optimized, possibly interpolated performance target.

The training of the learning-based control agent POL is explained in more detail below with reference to FIG. 1.

Training should generally be understood as meaning optimizing a mapping of input data of a machine learning module, here the control agent POL, to its output data. This mapping is optimized during a training phase in accordance with predefined criteria. A performance induced by control actions, in particular in the case of control models, or a prediction error in the case of prediction models, can be used as a criterion. The training can be used for example to set or optimize networking structures of neurons of a neural network, weights of connections between the neurons or other setting parameters of the machine learning module such that the predefined criteria are met as well as possible. The training can thus be regarded as an optimization problem. A multiplicity of efficient optimization methods is available for such optimization problems in the field of machine learning, in particular gradient-based optimization methods, gradient-free optimization methods, backpropagation methods, particle swarm optimizations, genetic optimization methods and/or population-based optimization methods. It is thus possible to train in particular artificial neural networks, recurrent neural networks, convolutional neural networks, perceptrons, Bayesian neural networks, autoencoders, variational autoencoders, Gaussian processes, deep learning architectures, support vector machines, data-driven regression models, k-nearest neighbor classifiers, physical models or decision trees.

In the present case, the control agent POL, as already indicated above, is intended to be trained to output a control signal optimized with respect to the performance target set by the respective target setting value when operating data relating to the machine M and a respective target setting value are fed in.

For this purpose, the machine controller CTL has a first performance evaluator TEV which can be set to a multiplicity of different performance targets by inputting target setting values. The first performance evaluator TEV serves the purpose of determining a performance value for the machine M that is specific to a respectively set performance target on the basis of operating data relating to the machine M.

For example, the first performance evaluator TEV can be initially set by the target setting value to determine an efficiency of the machine M as a performance target in order to determine a current efficiency of the machine M on the basis of the operating data, for example on the basis of measured power values. Subsequently, the first performance evaluator TEV can be set, for example, to determine a pollutant emission of the machine in order to determine a current pollutant emission of the machine M on the basis of operating data, for example on the basis of measured emission values.

For training the control agent POL, a generator GEN of the machine controller CTL generates a multiplicity of different vector-valued training target setting values TX, by which a multiplicity of different performance targets PT1, PT2, . . . can be set.

Furthermore, current operating data BD relating to the machine M are continuously fed into an input layer of the control agent POL together with a respective training target setting value TX as input data. Parallel thereto, the respective training target setting value TX is fed into the first performance evaluator TEV in order to set it to a respective performance target PT1 or PT2, . . . . In addition, the operating data BD are also transmitted continuously to the first performance evaluator TEV.

The control agent POL derives a control signal CS from the fed-in operating data BD and the respective training target setting value TX, which control signal is used to control the machine M. Parallel thereto, the first performance evaluator TEV determines, on the basis of the current operating data BD, a performance value PT that is specific with respect to the currently set performance target PT1 or PT2, . . . . The performance value quantifies how the current control of the machine M by the control signal CS has an effect on the respectively set performance target PT1 or PT2, . . . . Alternatively or additionally, the performance-target-specific performance values PT can also be determined by the first performance evaluator TEV by a simulation of the machine M or on the basis of stored operating data and control data relating to the machine M.

The above procedure is carried out for each of the generated training target setting values TX with respective operating data BD.

The determined performance-target-specific performance values PT are returned—as indicated by a dashed arrow in FIG. 1—from the first performance evaluator TEV to the control agent POL. On the basis of the returned performance values PT, the control agent POL is trained to optimize, in particular to maximize, the performance values PT at least on statistical average. That is to say, setting parameters of the control agent POL are set in such a way that the performance values PT is optimized across all performance targets PT1, PT2, . . . . A multiplicity of efficient optimization methods, in particular reinforcement learning methods, are available for carrying out such optimization. A particularly efficient method is described, for example, in the publication “Learning Control Policies for Variable Objectives from Offline Data”, by M. Weber, P. Swazinna, D. Hein, S. Udluft and V. Sterzing, arXiv:2308.06127v1 [cs.LG], of Aug. 11, 2023.

As a result of the feeding of a respective training target setting value TX into the control agent POL and the parallel setting of the corresponding performance target PT1 or PT2, . . . in the first performance evaluator TEV, the control agent POL is enabled by the training to optimize the control signals CS with regard to the performance target PT1 or PT2, . . . corresponding to the respectively fed-in training target setting value TX. In many cases, it has been found that a control agent trained in this way, in this case POL, has good interpolation and abstraction properties. That is to say, even if only a few individual performance targets are used during training, new combinations of these performance targets are generally also optimized relatively well when controlling the machine M by way of the trained control agent POL.

FIG. 2 illustrates the machine controller CTL with the trained control agent POL when controlling the machine M. The machine controller CTL should be able to be adapted to changing operating or environmental conditions during the ongoing operation of the machine M.

For this purpose, current operating data BD relating to the machine M are continuously fed as input data into the input layer of the trained control agent POL. Parallel thereto, the operating data BD are also fed continuously into a second performance evaluator EV of the machine controller CTL. The second performance evaluator EV serves the purpose of continuously measuring a performance of the machine M that is superior to the individual performance targets PT1, PT2, . . . on the basis of the operating data BD fed in.

In this case, the superior performance can relate in particular to operating conditions, operating states and/or performance targets which were not yet relevant or not accessible during the training of the control agent POL. For the present exemplary embodiment, it is assumed that the superior performance relates to a plurality of superior performance aspects, for example a material load and a total pollutant emission. In embodiments, frequencies or probabilities of limit values being exceeded in the case of the material load and in the case of the total pollutant emission can be determined by the second performance evaluator EV. Correspondingly, a currently determined superior performance is represented and quantified in each case by a superior performance vector P having a plurality of vector elements. The superior performance vectors P are continuously determined and output by the second performance evaluator EV on the basis of the operating data BD fed in.

Furthermore, the generator GEN generates a multiplicity of different vector-valued target setting values X for setting a multiplicity of different performance targets PT1, PT2, . . . . The vector elements of a respective target setting value X can be assigned quasi-continuously. As already mentioned above, the trained control agent POL can be caused by a respective target setting value X to output a control signal CS optimized with respect to the respectively set performance target PT1 or PT2, . . . .

In the present exemplary embodiment, the target setting values X are generated by varying a first vector-valued target setting value X1 by random vectors V. The first target setting value X1 can be initialized at the beginning of embodiments of the method with a vector known as reliable. The random vectors V are generated by the generator GEN in a randomly distributed manner, for example according to a Gaussian distribution with an average value of zero and a predefined spread. The spread is for example selected in such a way that, on the one hand, the variations have no significant effect on the control of the machine, and, on the other hand, gradients can still be determined in a sufficiently stable manner according to the target setting value.

Specifically, the target setting values X are generated in the present exemplary embodiment by first adding a respectively generated random vector V to the first target setting value X1 in order to obtain X=X1+V. The target setting value X obtained then remains constant over a predefined time period T, after the expiry of which the same random vector V is subtracted from the first target setting vector X1 in order to set the target setting value X to X1−V. After the predefined time period T has expired again, a new random vector V is then generated on a random basis. The time period T can be selected such that the superior performance can be determined sufficiently accurately during this time period T. Alternatively or additionally, a respective change in the target setting value X can be triggered by a predefined event.

The above steps of generating a random vector V and adding it to and subtracting it from the first target setting value X1 are iterated continuously in order to generate the multiplicity of different target setting values X.

The above-described procedures for generating the target setting values X can also be used by the generator GEN to generate the training target setting values TX.

The target setting values X generated by the generator GEN are fed into the input layer of the trained control agent POL together with the respectively current operating data BD as input data. By the varied target setting values X, the trained control agent POL, as described above, is set to slightly changed performance targets PT1, PT2, . . . after each expiry of the time period T. Correspondingly, the trained control agent POL continuously derives control signals CS on the basis of the current operating data BD, the control signals being optimized with respect to a respectively set performance target PT1, PT2, . . . . The control signals CS optimized in a performance-target-specific manner are continuously transmitted by the trained control agent POL to the machine M in order to control the latter.

In order to optimize the superior performance, the machine controller CTL also has an optimizer OPT. The target setting values X generated by the generator GEN and the superior performance vectors P, which were each measured under the influence of a respective target setting value X, are fed into the optimizer OPT. For this purpose, the performance vectors P are transmitted from the second performance evaluator EV to the optimizer OPT.

On the basis of the superior performance vectors P and the target setting values X, the optimizer OPT determines a target setting value OX which optimizes the superior performance vectors P and thus the superior performance.

For this purpose, the optimizer OPT carries out a gradient descent method. In this case, gradients of the superior performance vectors P are determined according to the target setting value X which in this case is vector-valued. Insofar as the target setting values X are varied as described above, the gradients can be calculated numerically by forming difference quotients. The gradients determined are combined to form a Jacobi matrix J according to Jₖₗ=∂Pₖ/∂Xₗ, where Xₗ denotes the vector elements of X and Pₖ denotes the vector elements of P.

Proceeding from this, that vector a which minimizes the Euclidean norm of the vector

$${J}^{T *} a = {\sum }_{k = 1}^{n} {a}_{k} \partial {P}_{k} / \partial {X}_{l}$$

under the secondary conditions aₖ>=0 and aₗ+ . . . +aₙ=1 is determined, where J^{T} denotes the matrix transposed to J and aₖ, k=1, . . . , n denotes the vector elements of a. The vector J^{T}*a resulting from the minimization then generally indicates a descending direction for the vector-valued target setting value X, along which a plurality of vector elements of a respective performance vector P are improved simultaneously. A corresponding optimization method is described, for example, in the publication “Multiple-Gradient Descent Algorithm (MGDA)” by Jean-Antoine Desideri, [Research Report] RR-6953, 2009, inria-00389811v2.

On the basis of the determined descending direction, a target setting value X^{N+1} which is generally improved with regard to the superior performance, can be determined from a present target setting value X^{N} according to

$${X}^{N + 1} = {X}^{N} - µ {\sum }_{k = 1}^{n} {a}_{k} \partial {P}_{k} ( {X}^{N} ) / \partial {X}_{l} ,$$

where μ denotes a predefinable attenuation or weighting factor. In an embodiment, the right-hand side of this equation can be checked, before it is assigned to the new target setting value X^{N+1} in order to determine whether it is within a predefined tolerance range. If so, X^{N+1} is set to the value of the right-hand side. Otherwise, μ can be reduced or a permissible default value can be assigned.

The above procedure can be repeated successively until a resulting sequence of target setting values X^{N}, N=1, 2, . . . satisfies a predefined convergence criterion. The resulting final value of the sequence is then output by the optimizer OPT as the target setting value OX that optimizes the superior performance.

The output target setting value OX is fed by the optimizer OPT both into the input layer of the trained control agent POL and into the generator GEN.

The trained control agent POL is caused by the target setting value OX to derive control signals CS from the operating data BD, the control signals being optimized with regard to the superior performance. Accordingly, the machine M is controlled by the generated control signals CS in such a way that the superior performance is optimized.

In this way, the control of the machine M during ongoing operation can be adapted to new performance aspects which are not yet foreseeable during the training of the control agent POL.

In addition, the generator GEN is caused to update the first target setting value X1 by the feeding-in of the target setting value OX. In this case, the first target setting value X1 can be replaced in particular by the target setting value OX which then functions as a new first target setting value X1. In this case, the subsequently generated target setting values X—as described above—are generated as small variations of the target setting value OX. In this way, gradients of the superior performance vectors P can also be determined according to the target setting value X during ongoing optimized operation of the machine M and used for the continuous adaptation of the control.

Although the present invention has been disclosed in the form of embodiments and variations thereon, it will be understood that numerous additional modifications and variations could be made thereto without departing from the scope of the invention.

For the sake of clarity, it is to be understood that the use of “a” or “an” throughout this application does not exclude a plurality, and “comprising” does not exclude other steps or elements.

1. A computer-implemented method for controlling a machine, the method comprising:
a) training a learning-based control agent to output a control signal, optimized with respect to a performance target of the machine, for controlling the machine as a result of operating data relating to the machine and a target setting value being fed in, wherein a multiplicity of different performance targets can be set by the target setting value;
b) generating a multiplicity of different target setting values;
c) capturing current operating data relating to the machine and feeding into the control agent together with a respective one of the generated target setting values;
d) controlling the machine by a control signal respectively output by the control agent;
e) determining, for different target setting values, in each case a performance of the machine that is superior to the individual performance targets; and
f) determining a target setting value that optimizes a superior performance, the target setting value being used in further operation of the machine.

2. The method as claimed in claim 1, wherein
the control agent is trained in advance by
providing a performance evaluator wherein different performance targets of the machine can be set;
generating a multiplicity of training target setting values;
feeding operating data relating to the machine into the control agent together with a respective one of the training target setting values, wherein, in parallel thereto, a respective performance target is set in the performance evaluator by the respective training target setting value;
determining a performance value specific to the respectively set performance target by way of the performance evaluator for controlling the machine by a control signal output by the control agent; and
training the control agent to optimize the performance values.

3. The method as claimed in claim 1, wherein the multiplicity of target setting values are generated by varying a first target setting value many times, wherein a statistical or maximum spread of the variations is limited by a predefined tolerance threshold; and
in that the first target setting value is updated by the target setting value that optimizes the superior performance.

4. The method as claimed in claim 3, wherein
a respective variation is triggered by an expiry of a predefined time period and/or by a predefined event.

5. The method as claimed in claim 1, wherein
a gradient descent method is used to determine the target setting value that optimizes the superior performance.

6. The method as claimed in claim 5, wherein the superior performance is quantified by a superior performance vector having a plurality of vector elements,
in that a check is carried out in order to determine whether there is a descending direction for the target setting value, along which a plurality of vector elements of the superior performance vector are improved simultaneously; and
in that, as a result of a positive check result, the target setting value is shifted in the direction of this descending direction.

7. The method as claimed in claim 1, wherein a plurality of identical machines is controlled by the trained control agent, wherein for the different target setting values in each case
the superior performance of each machine is measured, and
these measurements are averaged over the machines; and
in that a target setting value that optimizes the averaged superior performance is determined and used in the further operation of the machines.

8. The method as claimed in claim 1, wherein a plurality of identical machines is controlled by the trained control agent, wherein a target setting value which optimizes the superior performance of each machine is respectively determined for the latter,
in that the determined optimizing target setting values are averaged; and
in that the averaged optimizing target setting value is used in the further operation of the machines.

9. A machine controller configured to carry out all method steps of a method as claimed in claim 1.

10. A computer program product, comprising a computer readable hardware storage device having computer readable program code stored therein, the program code executable by a processor of a computer system to implement a method as claimed in claim 1.

11. A computer-readable storage medium comprising a computer program product as claimed in claim 10.
